(19) United States
(12) Patent Application Publication
(10) Pub. No.: US 2019/0063642 A1
(43) Pub. Date: Feb. 28, 2019

(54) ONSITE REAL-TIME MANUFACTURING OF LONG CONTINUOUS JOINTLESS PIPES

(71) Applicant: Mohammad Reza Ehsani, Tucson, AZ (US)

(72) Inventor: Mohammad Reza Ehsani, Tucson, AZ (US)

(21) Appl. No.: 15/684,928

(22) Filed: Aug. 23, 2017

(51) Int. Cl. F16L 11/24; F16L 11/02; B29C 65/48

(52) U.S. Cl. CPC F16L 11/24; B29L 2023/22; B29C 65/48; F16L 11/02

(57) ABSTRACT

Methods and systems are disclosed for onsite real-time manufacturing of any length, shape, size, and any thickness pipe. Strips of fabrics saturated with resin are helically wrapped around desired shape mandrels in one direction and removed, at least partially cured, to form such pipes onsite. The system can be mounted on a moving vehicle to manufacture and lay down any length pipe as it moves, or the system can be stationary. Disclosed pipes eliminate almost all weaknesses of plastic, metal and concrete pipes and noticeably reduce costs of transportation as well as manufacturing. One of the advantages of the disclosed pipes is that they have no joints, limiting the leakage and other problems associated with joints in ordinary pipes. Another advantage of the disclosed pipes is that it can have any number of desired layers at any desire cross-section of the pipe.

### CROSS-REFERENCE(S) TO RELATED APPLICATION(S)

This application is related to the U.S. Provisional Patent Applications No. 61/633,685, filed on Feb. 16, 2012, titled “Long Continuous Onsite-Manufactured Pipe” and the U.S. patent application Ser. No. 13/488,359, filed on Jun. 4, 2012, titled “Continuous Onsite-Manufactured Pipe,” both of which are incorporated herein in their entirety by reference.

### TECHNICAL FIELD

This application relates generally to construction of pipes. More specifically, this application relates to a method and apparatus for onsite real-time manufacturing of pipes of any length and any size and shape.

### BRIEF DESCRIPTION OF THE DRAWINGS

The drawings, when considered in connection with the following description, are presented for the purpose of facilitating an understanding of the subject matter sought to be protected.

FIG. 1 shows an example of real-time manufacturing of infinite-length pipes;

FIG. 2 shows an example 3D-fabric to be used by itself or as a spacer-sheet in the formation of a pipe;

FIG. 3 shows another example of real-time manufacturing of infinite-length pipes;

FIG. 4A is an example illustration of a longitudinal cross-section of the pipe manufactured by the apparatus of FIG. 3; and

FIG. 4B is an example illustration of a longitudinal cross-section of the pipe manufactured by the apparatus of FIG. 1.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed.

For centuries pipes have been used to carry fluids, gases, etc. for water, wastewater, gas, oil, mining and other industries. All these pipes, especially for large projects, are manufactured in pieces that are typically 16-24 feet long and are shipped by trailers or trains to the jobsite for installation. During the installation process, the short pieces are joined together to create a longer pipe. In buried pipes, a trench must be excavated to place the pipe below the ground.

There are several shortcomings with such a system. First, the shipping is very costly as often these pipes are bulky and hollow; in fact the trucks carry a lot of “empty” and unused space enclosed within the hollow pipes. When larger diameter pipes (4-ft and larger) are transported only a few pieces of pipe can be placed on a truck bed which adds tremendous expense to the project. Second, the pipe sections are very heavy and require heavy lifting equipment onsite to remove the pipe from the truck bed and position it in the trench. Third, the joints in all pipes are the major source of leakage. There are numerous organizations such as ASCE and EPA that provide statistics on the continuous waste of water, and leakage of pollutants such as sewer, gas, oil, etc., and waste of other resources because of leakage through the pipe joints while contaminating the surrounding areas. The joints are also a point where roots can penetrate sewer pipes, for example, causing clogging of such pipes. Forth, when steel or concrete pipes are used, the steel in these pipes corrodes over time, causing failure of the pipes which in turn incur major repair or replacement costs. Fifth, in industries such as gas and oil, where steel pipes are frequently used, cathodic protection systems must be installed to protect these pipes against corrosion. These systems require continuous monitoring and replacement of components to ensure proper operation. These costs become significant over the life of the pipe. Sixth, the electrical current that passes through gas or oil pipes, for example, can become stray and accelerate corrosion of other nearby metallic structures. This, for example, is a concern of the electrical utilities where their steel poles corrode at a much faster rate due to these stray currents. Depending on the strength of the current, a pipe may adversely affect a utility pole that is hundred feet or more away from the pipe. Seventh, long pipes manufactured by this customary methods have larger outer diameter wherever pieces are joined together. This is an important problem, for example if the pipes are to be used as liners within older pipes.

The construction of currently used pipes that are made of steel, concrete or plastics (e.g. PVC, fiberglass, etc.) requires major manufacturing equipment that must be housed in a factory and which are not portable. For example, the equipment needed to melt the steel or roll a steel sheet into a cylindrical pipe is very bulky and heavy Likewise, mixing of concrete and casting it in a mold to produce a concrete pipe is very difficult and does not lend itself to onsite manufacturing. Even in the case of fiberglass or other plastic pipes, their manufacturing requires a great deal of heat and spinning equipment (since many of these pipes are cast in centrifugal rotating machines), which require large spaces and facilities and are generally not portable to job sites. Therefore, such pipes can never be constructed onsite and in real-time on an “as-needed” basis.

Briefly described, methods and articles of manufacture are disclosed for replacing, repairing, reinforcing existing pipes, and onsite real-time manufacturing of new pipes of various shapes and sizes and lengths, with minimum cost, effort, and time. These methods, systems, and articles of manufacture can replace an entire pipe or a part or a segment of a pipe or repair a pipe or a structural member from outside, inside, or both. With the new methods, a vehicle, while moving, outputs and discharges, in real-time, a continuous pipe in the opposite direction of the vehicle's movement. In this operation the speed of the discharged pipe with respect to the vehicle is substantially the same as the speed of the vehicle with respect to the surface on which the pipe is laid. With such an arrangement the laid pipe will not have any movement relative to the surface on which it is placed and the vehicle may continue its movement for miles while placing a continuous pipe in a ditch of the same length, for example.

In some embodiments the vehicle may be at rest while the discharged pipe is being pulled, for example inside a damaged or old pipe, at the same speed as the pipe is being generated and manufactured. In another embodiment, for example for lining a well, the equipment can be positioned directly above the well and as the pipe is being manufactured it is pushed into the well at substantially the same speed as the pipe is being manufactured.

Pipe manufacturing and installation, and also pipe repair and replacement can be expensive, cumbersome, and time consuming. Pipes can get damaged due to a variety of factors, such as earthquakes, overloading, traffic, wear and tear, corrosion, explosions, and the like. If damage does occur to a pipe, a cost-effective and speedy method of repair is clearly desirable. While pipe repair and replacement are emphasized in this disclosure, other structures, damaged or undamaged, can benefit from the disclosed methods and apparatus. The disclosed onsite manufactured pipes can even be used as concrete molding, such as for bridge columns, and can be left around the concrete structural elements for protection.

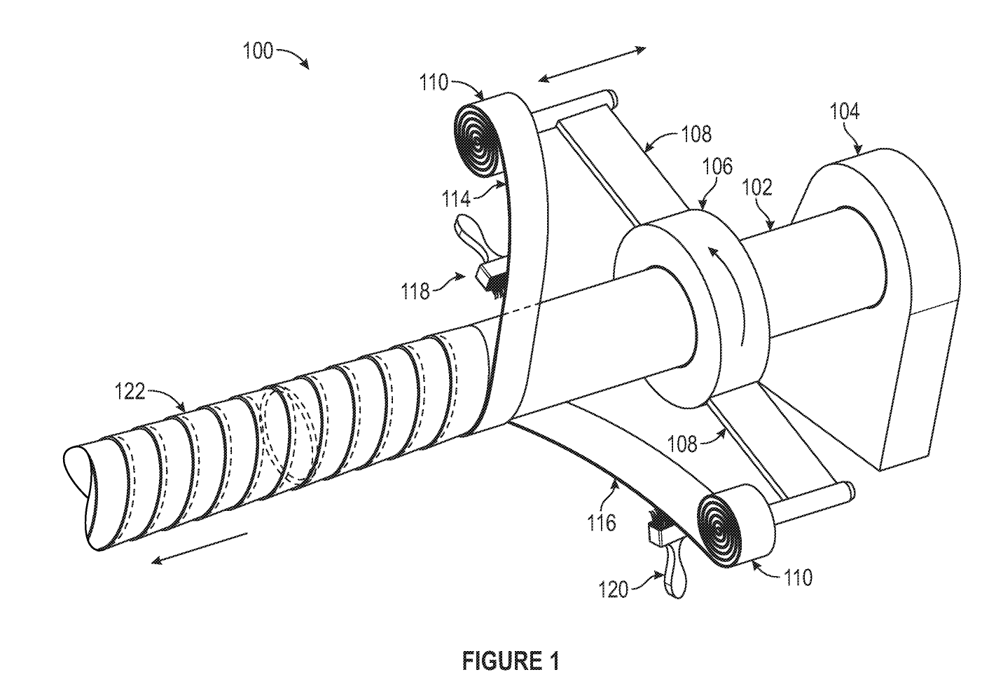

FIG. 1 shows an example of real-time manufacturing of potentially infinite-length pipes. Similarly, when it is desired to create a cavity inside a concrete element, these inexpensive pipes can be inserted inside the mold prior to placement of concrete, resulting in a cavity the same shape and size as the pipe.

In various embodiments, the pipe may be constructed from fiber-reinforced material, such as Fiber Reinforced Polymer (FRP) to give the pipe more resistance against different types of loading, such as blast and earthquake loading. Those skilled in the art will appreciate that many types of reinforcement fibers may be used for manufacturing the disclosed pipes including polymer, fiberglass, metal, cotton, other natural fibers, and the like. The sheet materials used in manufacturing these pipes may include fabrics made with fibers such as glass, basalt, carbon, Kevlar, Nomex, aluminum, and the like, some saturated with a polymer such as polyester, vinyl ester, or epoxy for added strength, wear resistance, and resilience.

The fibers within a reinforcement sheet may be aligned in one direction, in cross directions, randomly oriented, or in curved sections to provide various mechanical properties, such as tearing tendency and differential tensile strength along different directions, among others. Reinforcement sheets with continuous fibers along their longitudinal axis and cross fibers substantially perpendicular to the longitudinal fibers lend themselves to more accurate calculations of mechanical properties.

Other multi-dimensionally woven or stitched materials, known as multi-axial fabrics or 3D fabrics, can also be used in the manufacture of these pipes. Such materials are currently obtainable from companies such as Fiber Materials, Inc., 5 Morn Street, Biddeford, Me. The thickness of some 3D fabrics increases as the fabrics are impregnated by liquids such as resin. In the following disclosure, the term “3D fabrics” is used specifically for such fabrics. The word “fiber” in this specification is also used for any sheet of material the strength of which, at least partially and at least in one direction, depends on fibers of some kind, whether the fibers are woven, stitched, or held together by other means such as glue.

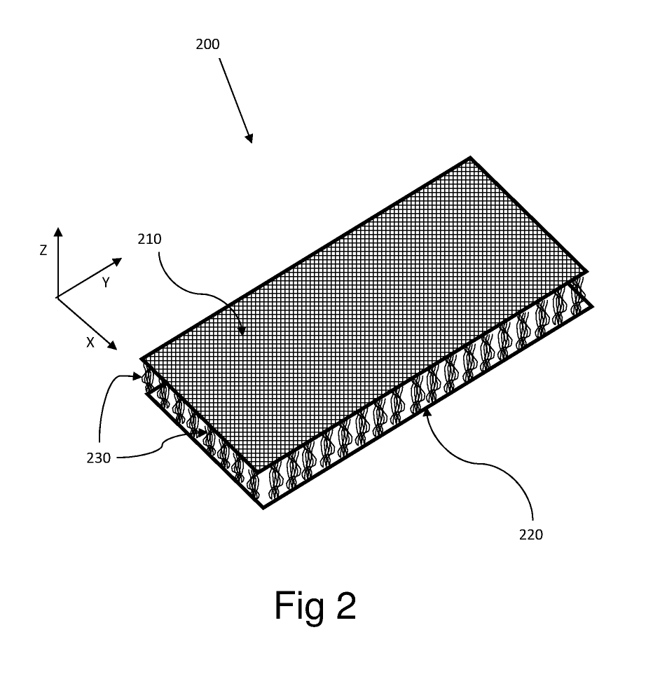

A 3D fabric is a special type of fabric made, for example, with glass, carbon, or Kevlar reinforcing fibers. The 3D fabric 200, illustrated in FIG. 2, is woven as two fabric layers 210 and 220 that are connected with short fibers 230 of glass, carbon or Kevlar fibers. During application of 3D fabrics, both layers 210 and 220 of the fabric can be saturated with a resin such as epoxy, polyester or vinyl ester at the same time. During the curing process, the short fibers 230 will rise causing further separation between the two layers 210 and 220 of the fabric to form a rigid 3D structure. This process results in a cured three-dimensional structure with a certain thickness and stiffness that is more than the thickness and stiffness of the 3D fabric 200 before the application of the resin.

The resulting thickness, after the application of resin, is determined by the length of the short fibers 230 connecting the two fabric layers 210 and 220 together. Typical fiber lengths are 2 to 30 mm. I-beams are commonly used in construction where the two flanges are separated by a web. The short Z-direction fibers in a 3D fabric work similar to the web of an I-beam. The result is a structure that is much stiffer and stronger than if the two X-Y layers of fabric were directly bonded together without any separation between them. 3D fabrics are available through a small number of manufacturers worldwide including Jushi Beihai Fiberglass Co., LTD in China. Additionally, the hollow space between the two faces of the 3D fabric may be filled with various filler materials such as foam, rubber, resin, concrete, rebars and the like.

The reinforcement layers that form the onsite manufactured pipes may be laminated in the field using epoxy, various glues, or similar adhesives to create a laminated composite that is stiffer than the sum of the individual reinforcement layers. However, in some embodiments a single layer may suffice. Different reinforcement layers may use sheets with fibers oriented in different directions, such as orthogonal directions, with respect to other sheets to further reinforce the laminated composite. Other materials, as will be described below, such as foams, honeycomb sheets, multi-axial fabrics, or 3D fabrics may be included in the laminate layers to achieve different desirable mechanical, structural, and other characteristics. In various embodiments a single layer of FRP material or a single layer of 3D fabrics may be all that the calculations require. Those skilled in the art will recognize that many other types of reinforcement layers such as honeycomb, hollow structures, or laminated structures are possible without departing from the spirit of the present disclosures.

The interior surface of the pipe, depending on the fabric, can provide abrasion and chemical resistance, for example when the pipe is carrying chemicals and slurry-type materials that could result in excessive wear on the surface of the pipe. A single layer or multiple layers of the pipe wall may also be designed to resist internal pressure of the pipe.

Example materials for building pipes and their reinforcement layers and sheets are FRP and resin or any other fabric of choice and resin, and in some embodiments spacer sheets, all of which are very light-weight and can be delivered to the job site or even stored on a mobile platform such as a trailer or a truck that can move along the trench where the pipe is being made or repaired.

FIG. 1 illustrates an example method and apparatus 100 for real-time manufacturing of an infinite-length pipe 122. FIG. 1 shows a mold or mandrel 102 that represents the desired size and shape of the pipe being manufactured and that is attached to a base 104 to form a cantilever. The base 104 itself is fixed to a vehicle, such as the bed of a truck. Those skilled in the art will realize that the cross-section of the mandrels and manufactured pipes need not be circular and can have any desired geometric shape, such as oval, square or polygon.

A rotating member 106 spins around the mandrel 102 only in one direction. In some embodiments the rotating member 106 may be replaced by manual labor. In the example depicted in FIG. 1, the rotating member 106 revolves counter-clockwise around the mandrel 102 and is free to move towards both ends of the mandrel 102. In various embodiments the rotating member 106 may not move in the direction of the axis of the mandrel 102. The rotating member 106 is attached to one or more arm 108, each of which carries a spool 110 of FRP and/or 3D fabric strips 114 and 116, for example. As schematically illustrated, the fabric strips 114 and 116 are impregnated by resin while passing by brushes 118 and 120, respectively. Those skilled in the art recognize that the impregnation of the strips 114 and 116 may be achieved by several other means such as soaking the strips with resin after the strips 114 and 116 are wound around the mandrel 102 or while still on the spools 110, or spraying the strips with resin while being wound. Another method commonly referred to as “prepreg” is to saturate the strips 114 and 116 with a resin prior to winding them around the spools 110.

The windings over the mandrel are helical and each turn may overlap a previous one. In practice, for example, the strips may be 2 foot wide and have 6 inch overlap. In various examples only the overlapping part of the strips 114 and 116 may be impregnated by resin so that the resin is not smeared on the mandrel or be wasted. In some embodiments one layer of fabric may have overlapped strip turns while another layer may not have any overlaps. In other embodiments both layers may not have any overlap. For example in FIG. 1, the turns of strip 114 may be overlapped while the turns of strip 116 may lay adjacent to each other without any overlap.

In some embodiments in which the pipe is laid in a trench, the angular speed of the rotating member 106 is automatically controlled to be a function of the vehicle's linear speed such that the speed of the discharged pipe with respect to the vehicle is substantially the same as the speed of the vehicle with respect to the surface on which the pipe is laid. While the rotating member cannot go back and forth over the wound strips and can only wind in one direction, it is free to move along the axis of the mandrel 102 to compensate for the sudden changes of the speed of the vehicle, if needed. However, assuming that the speed of the vehicle is constant or gradually changing, the rotating member 106 will be rotating at the same location over the mandrel 102. In those embodiment in which the rotating member 106 does not have any linear motion over the mandrel 102, a closed-loop control system with more complicated feedback and more complicated control signal may be needed to keep the winding uniform throughout the pipe.

Another example control system is controlling the angular speed of the rotating member 106 in a negative feedback loop wherein the input is a desired location of the rotating member 106 on the mandrel 102 and, for example, the linear speed of the pipe 122 with respect to the mandrel 102 is fed back. Such control systems are known to those skilled in the art. Other control systems may also be envisioned to at least keep the rate of fabricating a pipe 122 the same as the rate of discharging of the pipe from the mandrel 102.

The rotating member 106 may carry one or several coils or spools 110 of the same or different materials. In the preferred embodiment it carries a single spool of a two or three dimensional fabric. In different embodiments, to speed up the curing process of the resin, the mandrel 102 may be heated, may have perforations on its surface for hot air or gas to be pumped through, may illuminate ultra-violate light, or the like. In other embodiments, not shown in FIG. 1, the heating or light may be provided by an external device positioned around the outside of the mandrel. In other embodiments the resin may be a fast curing resin which cures within a few minutes. One such resin is manufactured by EFI Polymers (Denver, Colo.) and cures fully in 3 minutes if heated to 300 degrees Fahrenheit. In various embodiments the full curing of the pipe may continue for a while after removal from the mandrel.

In some embodiments a release agent may be applied to the mandrel 102 or wrap a plastic/nylon sheet around the mandrel 102, or use any other means, to allow easy movement of the pipe 122 over the mandrel 102. In other embodiments a polished and smooth mandrel and/or a slightly tapered mandrel may be employed. If desired, one may wrap any number of spacer layers such as honeycomb or multi-axial or 3D fabric type layers between any number of FRP layers. As briefly mentioned above, spacers are optional layers for achieving different desirable mechanical, structural, and other characteristics by utilizing, for example, hollow cells on a surface, and/or using wrinkled or corrugated material sheets, creating a largely hollow core layer, which may be filled with resin or other reinforcing material to increase its stiffness and strength. A spacer may be foam that is sprayed in the field or pre-formed into strips similar to NexCore produced by Milliken (Spartanburg, S.C.). A spacer may even be already manufactured laminated strip of FRP layers. If the spacer material is thick and/or stiff, the spacer may be scored to allow it to bend to fit around the curvature of the mandrel 102.

In various embodiments, a coating mechanism (not shown) such as a rotating spray gun or brush may be mounted at the free end of the mandrel 102. As the finished pipe 122 is being discharged from the mandrel, one or more layers of coating can be applied to the interior surface of the pipe. In some embodiments, the coating materials can be supplied through hoses placed inside the mandrel 102. These coatings can serve various functions, such as water tightness, potable water coating, abrasion resistance and the like. Many manufacturers such as 3M (St. Paul, Minn.) offer a wide range of such coatings.

In cases where the manufactured pipe is being inserted into a damaged host pipe to replace the function of a part of the damaged pipe, at least a part of the outside surface of the manufactured pipe such as its ends may be roughed, for example by sanding or by sand blasting or by spraying a mixture of sand and Resin, to enhance bonding of the pipe to the host pipe in the field.

The vehicle or platform carrying the mandrel 102 can travel alongside a trench. The above procedure allows the light-weight constituent materials of the pipe, namely FRP, resin and the optional spacer layer to be delivered to the crew while the pipe is constructed and placed. If desired, the raw materials can be placed on the same moving platform as the mandrel 102 or on a separate moving platform adjacent to the mandrel platform for higher productivity.

In some embodiments, it is hard to build very long pipes without any joints and periodically along the length of the pipe, joints may be necessary based on different considerations, such as right-angle joints. Another advantage of the disclosed pipe is that it can be easily cut and spliced in the field. Splicing of the pipe will later require joints to connect the splice, where the above-mentioned joining systems can be used. Moreover, externally wrapped FRP bands can also provide a leak-proof and strong joint. Alternatively, a larger size pipe of similar construction disclosed here can be built and cut into, for example, 1-ft long slices, which can serve as coupling sleeves that would slip over the ends of adjoining pipes (about 6 inches on each pipe). The small annular space between the original pipe and the coupling sleeve can be sealed with an adhesive, a rubber gasket or a hydrophilic seal that would expand after exposure to water to create a compression seal between the coupling sleeve and the pipe. If the pipe diameter is large enough to allow man entry, the joint can be made internally with FRP, or clamps such as Weko Seal and/or other similar products that are readily available. The disclosed pipes are flexible enough to accommodate small radii of curvature.

The materials including resins used in the construction of the disclosed pipes may be selected from a family of environmentally safe products so that the finished pipe is safe for potable water. QuakeWrap, Inc. (Tucson, Ariz.), for example, provides such fibers and resins that meet the NSF-61 industry standards for potable water.

The disclosed pipes are extremely light and very strong. For example, these pipes weigh approximately 1 pound per square foot compared to a fiberglass pipe manufactured by Hobas Pipe USA (Houston, Tex.) that weighs over 16 pounds per square foot. While all components of the pipe (for example, FRP, resin, and spacer) work together to provide the stiffness and resistance to external loads (e.g. soil, traffic, impact, blast, etc.), the internal pressure rating of the pipe is primarily dependent on the interior FRP layer(s). A typical FRP layer is less than 0.05 inch thick; therefore, one may significantly increase the internal pressure rating of a pipe by adding one or more layers of FRP to the interior surface of the pipe, which will only cause a small increase in the pipe wall thickness and the weight of the pipe while increasing the pipe strength significantly.

The material strength of the pipe wall need not be uniform throughout the wall thickness since the major portion of the wall stresses under an external load is generated within the outer layer and inner layer of the pipe wall. Placing a spacer layer between the outer layer and the inner layer of the pipe wall closely resembles an I-beam web between the two I-beam flanges. The thicker the spacer layer, the less stress is created within the outer layer and the inner layer of the pipe wall. Additionally, the inner layer resists the internal pressure of the pipe and the outer layer provides protection against corrosion from soil or UV light, etc. In some embodiments with multiple layers the outer layer and the inner layer of the pipe wall are designed to carry all or most of the stresses caused by the external loads, while the spacer layer may experience some radial stress.

A further advantage of the disclosed pipe is that its strength can be easily increased or decreased at desired locations along the length of the pipe. For example, in a project where a 600-ft deep well is lined with a pipe, the pipe will be subjected to an internal pressure of 300 psi at the bottom of the well. However, this pressure gradually reduces to zero at the ground level. By reducing the number of layers of the FRP along the length of the pipe significant cost savings can be realized. For example, the lower 200 feet of the pipe may have 4 layers of FRP in the hoop direction, while 3 layers of FRP may be enough for the middle 200 feet and only 2 layers of FRP may suffice for the upper 200 feet.

In some embodiments to achieve different number of layers along the length of the pipe 122, a control system is adopted that, among other things, controls the amount of overlap of any two consecutive turns of the strip over mandrel 102. As an example such a control system may have the percentage of the overlap of the consecutive strip turns as its input while the output of the control system is the angular speed of the rotating member 106. Those skilled in the art realize that many control loops and feedbacks may be adopted and designed to achieve automatic control of the overlap amount and therefore the number of desired layers at desired locations. The input to such control systems may be manual and/or programmed.

Similarly, in some projects, a pipe may have to span across an opening such as a river. By adding more FRP layers; orienting the fibers of the strips along the axis of the pipe; and/or adding separate strips along the longitudinal axis of the pipe, the bending strength of the pipe can be readily increased over that crossing.

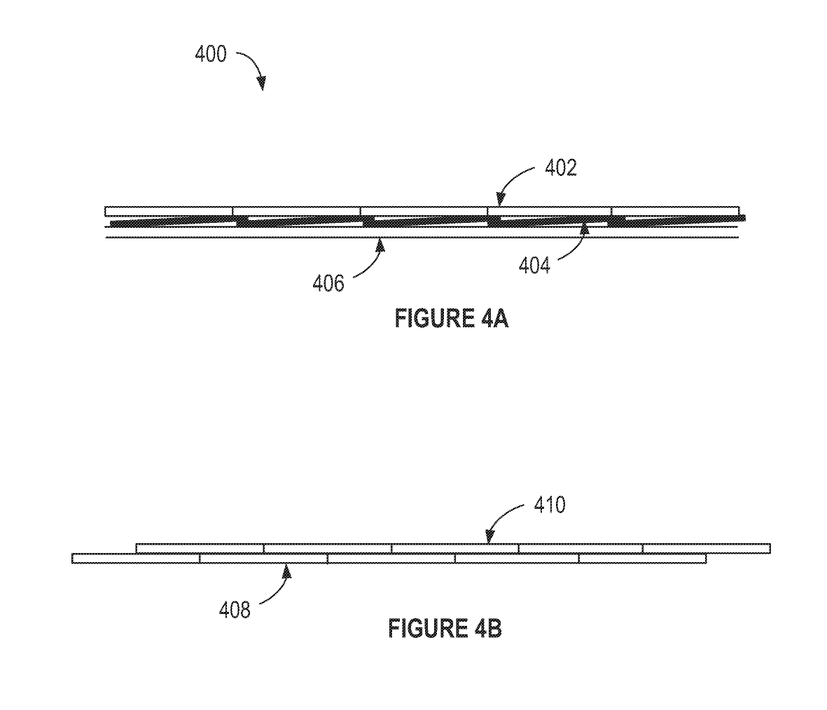

FIG. 4B is an example illustration of a longitudinal cross-section of the pipe 122 manufactured by the apparatus of FIG. 1. In this embodiment the strips of neither of the layers 408 and 410 are wound in an overlapped manner. In this Figure the inner layer 408 is wound with strip 114 and the outer layer 410 is wound with strip 116. In various embodiments either layer or both may be wound in an overlapped manner. In other embodiments the rotating member 106 may carry several spools 110 and form a pipe with several layers.

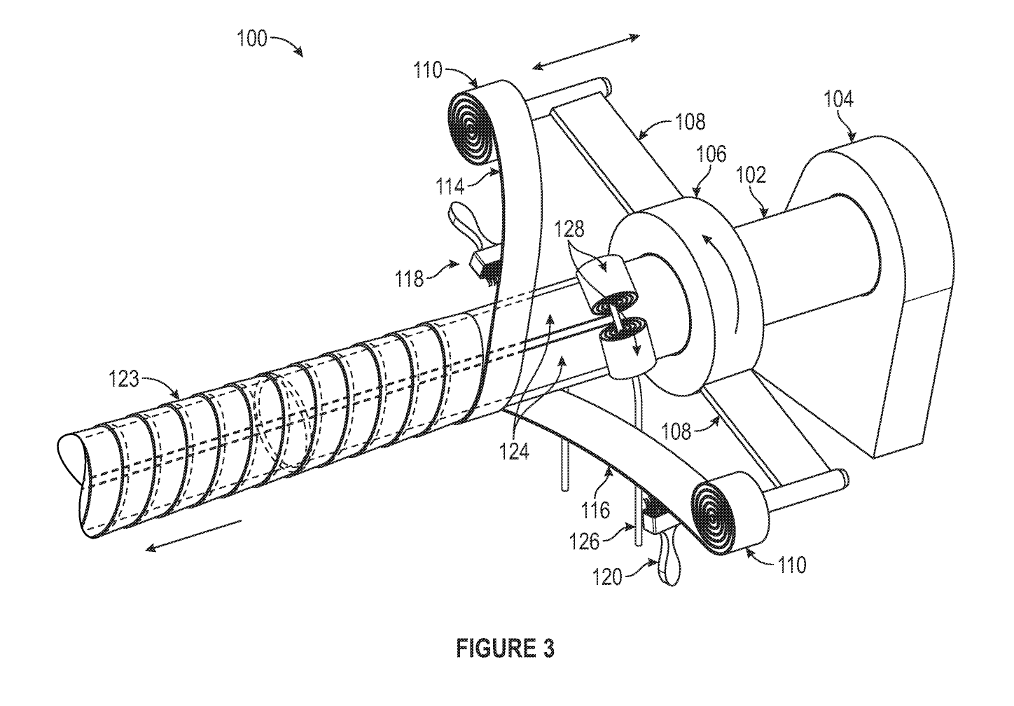

FIG. 3 illustrates a pipe manufacturing system similar to that of FIG. 1. As shown in FIG. 3, strips 124 are longitudinally laid over the mandrel 102 for additional bending strength. In some embodiments, member 126 that carries additional spools 128, does not revolve around the mandrel 102 and only moves along the axis of the mandrel 102. In the shown example, member 126 may be stationary over the mandrel 102 while keeping a distance from the rotating member 106, allowing the rotating member 106 to allow it to turn as well as going back and forth over the mandrel 102. In various embodiments, if member 126 is stationary over the mandrel 102, there will be no need to control its dispensing of strips 124. However, member 126 may also be controlled to dispense strips 124 at the same rate as the dispensing speed of pipe 123 with respect to the mandrel 102. In some embodiments member 126 may also include strip-cutters to cut strips 124 and stop dispensing additional longitudinal strips 124 wherever the design requires. As shown in the example of FIG. 3, there may be no need to have strips 124 all around the perimeter of mandrel 102. In some embodiments only one strip 124 may suffice. In embodiments in which the rotating member 106 also does not move along the longitudinal axis of the mandrel 102, member 126 may be located adjacent to the rotating member 106.

FIG. 4A is an example illustration of a longitudinal cross-section of the pipe 123 manufactured by the apparatus of FIG. 3. In this embodiment component 406 is the schematic illustration of the strip 124 that has been laid along the longitudinal axis of the mandrel 102. Component 404 illustrates the second layer wound with strip 114 in an overlapped manner. Component 402 shows the third layer wound with strip 116 in a non-overlapped manner. In various embodiments each of the layers wound over the longitudinal strips 124 may be wound in an overlapped or a non-overlapped manner. In other embodiments the rotating member 106 may carry several spools 110 and form a pipe with multiple layers.

Those skilled in the art will recognize that in various embodiments the rotating member 106 may not be physically mounted over the mandrel while it is able to wrap one or more strips of fabric around the mandrel. The rotating member may be separately attached to the same platform as the mandrel is and may have no physical contact with the mandrel.

In various embodiments the entire or part of the process of wrapping the strip(s) over the mandrel may be performed manually or by an open loop control system, the input of which may be provided manually.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method of onsite real-time manufacturing of long pipes, the method comprising:
attaching one end of a mandrel of any desired cross-section to a platform to form a cantilever on the platform;
placing a rotating member over the mandrel, wherein the rotating member rotates in one direction around the mandrel and moves along a longitudinal axis of the mandrel and carries one or more batches of FRP and/or 3D fabric strip;
helically wrapping the one or more fabric strips over the mandrel to form one or more layers of fabric around the mandrel;
impregnating the strip(s) by resin, at least partially, before or after wrapping; and
dislodging the wound strip(s) from the mandrel at a same rate as the strip(s) is wound, using a closed-loop or an open-loop control system or by a manual control system that keeps the rotating member substantially at a same location on the mandrel.

2. The method of claim 1, wherein each turn of at least one layer of the wrapped strip overlaps a previous turn, at least partially, and wherein the amount of the overlap is automatically or manually controlled and may be any number from 0% overlap to 100% overlap, at any particular time.

3. The method of claim 2, wherein number of desired layers of the fabric strip at any cross-section of the pipe is controlled by automatically adjusting the amount of overlap of consecutive turns and/or by the number of strips employed.

4. The method of claim 1, further comprising wrapping a layer of bond-inhibiting material over the mandrel before wrapping the resin-saturated fabric layers around the mandrel.

5. The method of claim 1, wherein more than one layer is wound over the mandrel by the rotating member and/ or wherein more than one kind of fabric is wound over the mandrel by the rotating member.

6. A method of real-time manufacturing of infinite-length pipes, the method comprising:
attaching one end of a mandrel to a moving or a stationary platform;
wrapping, helically, one or more fabric strips around the mandrel in one direction to form a pipe over the mandrel;
impregnating the strip(s) by resin, at least partially, before or after wrapping;
discharging, partially and continuously, the pipe from the mandrel; and
automatically controlling, by a closed-loop or an open-loop control subsystem or by manually controlling speed of formation of the pipe such that a rate of discharge of the pipe from the mandrel is substantially equal to a rate of formation of the pipe

7. The method of claim 6, wherein one or more layers of the wrapped strip are wound in an overlapped manner at least partially.

8. The method of claim 7, further comprising a closed-loop or an open-loop control subsystem to control an amount of overlap.

9. The method of claim 6, wherein a spacer layer is sandwiched between a first and a second fabric layers and wherein the first and the second fabric layers are designed to carry all or most of stresses caused by an external load on the pipe section.

10. The method of claim 6, wherein the fabric is a fiber-reinforced material, a Fiber Reinforced Polymer, a multi-directional woven fabric, or a 3D fabric and/or wherein curing of the resin is accomplished with light, heat, gas, liquid, or a combination thereof.

11. The method of claim 6, further comprising a negative-feedback control subsystem, an input of which is a desired number of layers at a desired cross-section of the pipe.

12. The method of claim 6, further comprising placing a fabric strip on the mandrel substantially along a longitudinal axis of the mandrel.

13. A system for manufacturing a pipe of any desired length, shape, and size, the system comprising:
a mandrel of any cross-section that is attachable to a stand from one end;
a rotating member that rotates in one direction around a longitudinal axis of the mandrel;
One or more spools of different or same fabric strips attached to the rotating member wherein the fabric strip(s) is helically wrapped over the mandrel to form a pipe over the mandrel;
One or more impregnators to at least partially impregnate the strip(s) by resin, before or after wrapping; and
a control subsystem to keep a rate of manufacturing the pipe substantially equal to a speed of the pipe leaving the mandrel.

14. The system of claim 13, wherein some layers of the wrapped strip may be wound in an overlapped manner, and wherein the system comprises an open-loop or closed-loop control subsystem to control an amount of overlap.

15. The system of claim 13, further comprising a control subsystem, an input of which is a desired number of layers at a desired cross-section of the pipe.

16. The system of claim 13, further comprising a nonrotating member placed over the mandrel, wherein the nonrotating member disposes a fabric strip on the mandrel substantially in a direction of an axis of the mandrel.

17. A method of real-time manufacturing of an infinite-length pipe with different number of layers at various locations of the pipe, the method comprising:
attaching one end of a mandrel to a moveable or a stationary platform;
depositing a first fabric strip over the mandrel wherein the deposited strip is substantially in a direction of longitudinal axis of the mandrel;
helically wrapping a second fabric strip over the mandrel such that each turn of the wrapped strip overlaps a previous turn by a desired amount to form a pipe over the mandrel;
impregnating the strip by resin, at least partially, before or after wrapping; and
continuously adjusting the amount of the overlap of the strip turns in response to the number of desired layers at different locations of the pipe; and
controlling, automatically or manually, a rate of wrapping the strip around the pipe as a function of the speed of the pipe with respect to the mandrel or controlling the speed of the pipe leaving the mandrel as a function of the rate of wrapping the strip around the pipe.

18. The method of claim 17, wherein more than one fabric strip is wound over the mandrel and/or wherein more than one kind of fabric is wound over the mandrel and wherein each additional wound layer has overlapped strip turns or non-overlapped strip turns.

19. The method of claim 17, wherein the pipe is at least partially cured before leaving the mandrel.

20. The method of claim 17, wherein the longitudinal strips are only deposited at desired locations along the length of the pipe.

21. The method of claim 17, further including a coating applicator at a free end of the mandrel for applying at least one desired coating to an inside surface of the pipe.
